(19) United States
(12) Patent Application Publication
(10) Pub. No.: US 2026/0032793 A1
(43) Pub. Date: Jan. 29, 2026

(54) ELECTRONIC DEVICE FOR REDUCING POWER CONSUMPTION THROUGH ENERGY RECOVERY AND CONTROL METHOD THEREOF

(71) Applicant: Samsung Electronics Co., Ltd., Suwon-si (KR)

(72) Inventors: Seungyong SHIN, Suwon-si (KR); Hyukjun JANG, Suwon-si (KR); Myungjoon KIM, Suwon-si (KR)

(73) Assignee: Samsung Electronics Co., Ltd., Suwon-si (KR)

(21) Appl. No.: 19/347,165

(22) Filed: Oct. 1, 2025

Related U.S. Application Data
(63) Continuation of application No. PCT/KR2024/002312, filed on Feb. 22, 2024.

(30) Foreign Application Priority Data
Apr. 13, 2023 (KR) 10-2023-0048669

(51) Int. Cl. H05B 45/44

(52) U.S. Cl. CPC H05B 45/44

(57) ABSTRACT

An electronic device includes a light-emitting diode, a power element, a charging element, memory storing instructions, and at least one processor operatively connected to the light-emitting diode, the power element, and the charging element. The electronic device supplies a first power from the power element to the light-emitting diode, based on the supply of the first power being stopped, charges a second power, which is a remaining power after emission of the light-emitting diode ends, using the charging element, ends the charge of the second power, and grounds a node connected to one end of the light-emitting diode.

### CROSS-REFERENCE TO RELATED APPLICATIONS

This application is a bypass continuation of International Application No. PCT/KR2024/002312, filed on Feb. 22, 2024, which is based on and claims priority to Korean Patent Application No. 10-2023-0048669, filed on Apr. 13, 2023, in the Korean Intellectual Property Office, the disclosures of which are incorporated by reference herein in their entireties.

### BACKGROUND

### 1. Field

The disclosure relates to an electronic device and a control method thereof, and more particularly, to an electronic device that reduces power consumption through energy recovery, and a control method thereof.

### 2. Description of Related Art

Various types of electronic devices are being developed. In particular, recently, various products including light-emitting diodes (LEDs) are being developed.

For example, an LED driving system to which time-division driving is applied (phase modulation (PM) driving, time-division amplitude modulation (AM) driving) may alternately operate a plurality of LEDs through time division. Power that remains in the LEDs and the circuit after the LEDs are turned off is emitted through a discharging circuit connected with the ground, and the emitted power is a factor that reduces system efficiency.

Accordingly, a method for further improving power efficiency of a circuit including LEDs is needed.

### SUMMARY

According to an aspect of the disclosure, there is proved an electronic device including: a first light-emitting diode; a power element; a first charging element; memory storing instructions; and at least one processor operatively connected to the first light-emitting diode, the power element, and the first charging element, wherein the instructions, when executed by the at least one processor individually or collectively, cause the electronic device to: supply a first power from the power element to the first light-emitting diode, based on the supply of the first power being stopped, charge a second power, which is a remaining power after emission of the first light-emitting diode ends, using the first charging element, and end the charge of the second power, and ground a node connected to a first end of the first light-emitting diode.

The electronic device may further include: a first switch connected between the first end of the first light-emitting diode and the power element; a second switch connected between the first end of the first light-emitting diode and the first charging element; and a third switch connected between the first end of the first light-emitting diode and a ground, and the instructions, when executed by the at least one processor individually or collectively, may cause the electronic device to: supply the first power to the first light-emitting diode by turning on the first switch, charge the second power in the first charging element by turning off the first switch and turning on the second switch, and ground the node by turning off the second switch and turning on the third switch.

The electronic device may further include a driving integrated circuit (IC) connected to a second end of the first light-emitting diode, and the instructions, when executed by the at least one processor individually or collectively, may cause the electronic device to, while the first switch is turned on, control the driving IC such that a current is applied to the first light-emitting diode.

The driving IC may be configured to, based on a voltage on the first and second ends of the first light-emitting diode being smaller than a predetermined voltage, not provide the current.

The instructions, when executed by the at least one processor individually or collectively, may cause the electronic device to: supply a third power charged in the first charging element to the first light-emitting diode by turning off the third switch and turning on the second switch, and supply the first power to the first light-emitting diode by turning off the second switch and turning on the first switch.

The instructions, when executed by the at least one processor individually or collectively, may cause the electronic device to, after supplying the third power to the first light-emitting diode, based on a difference between a voltage of the first light-emitting diode and a voltage of the power element being smaller than a predetermined difference, supply the first power to the first light-emitting diode by turning off the second switch and turning on the first switch.

The instructions, when executed by the at least one processor individually or collectively, may cause the electronic device to, after charging the second power in the first charging element, based on a voltage of the first light-emitting diode being smaller than a predetermined voltage, ground the node by turning off the second switch and turning on the third switch.

The electronic device may further include: a second light-emitting diode; a second charging element; a fourth switch connected between a first end of the second light-emitting diode and the power element; a fifth switch connected between the first end of the second light-emitting diode and the second charging element; and a sixth switch connected between the first end of the second light-emitting diode and the ground, and the instructions, when executed by the at least one processor individually or collectively, may cause the electronic device to control the first switch, the second switch, the third switch, the fourth switch, the fifth switch, and the sixth switch such that the first light-emitting diode and the second light-emitting diode alternately emit a light.

The instructions, when executed by the at least one processor individually or collectively, may cause the electronic device to: supply the first power from the power element to the second light-emitting diode by turning off the second switch, turning on the third switch, and turning on the fourth switch, charge a fourth power, which is a remaining power after emission of the second light-emitting diode ends in the second charging element, by turning off the third switch, turning on the second switch, turning off the fourth switch, and turning on the fifth switch, and ground another node to which the fourth switch, the fifth switch, and the sixth switch are connected by turning off the second switch, turning on the first switch, and turning off the fifth switch, turning on the sixth switch.

The instructions, when executed by the at least one processor individually or collectively, may cause the electronic device to: supply a fifth power charged in the second charging element to the second light-emitting diode by turning off the sixth switch and turning on the fifth switch, and supply the first power to the second light-emitting diode by turning off the fifth switch and turning on the fourth switch.

The electronic device may further include: a driving IC connected to a second end of the first light-emitting diode and a second end of the second light-emitting diode, and the instructions, when executed by the at least one processor individually or collectively, may cause the electronic device to, while the first switch is turned on, control the driving IC such that a current is applied to the first light-emitting diode, or while the fourth switch is turned on, control the driving IC such that the current is applied to the second light-emitting diode.

The second power may be a power remaining in the node and the first light-emitting diode.

According to an aspect of the disclosure, there is provided a control method of an electronic device, the control method including: supplying a first power from a power element to a light-emitting diode; based on a supply of the first power being stopped, charging a second power, which is a remaining power after emission of the light-emitting diode ends, using a charging element; and ending the charging of the second power, and grounding a node connected to one end of the light-emitting diode.

The supplying may include supplying the first power to the light-emitting diode by turning on a first switch connected between the one end of the light-emitting diode and the power element, wherein the charging may include charging the second power in the charging element by turning off the first switch and turning on a second switch connected between the one end of the light-emitting diode and the charging element, and wherein the grounding may include grounding the node by turning off the second switch and turning on a third switch connected between the one end of the light-emitting diode and a ground.

The control method may include controlling, while the first switch is turned on, a driving integrated circuit (IC) connected to the other end of the light-emitting diode such that a current is applied to the light-emitting diode.

### BRIEF DESCRIPTION OF THE DRAWINGS

The above and other aspects, features, and advantages of embodiments of the present disclosure will be more apparent from the following description taken in conjunction with the accompanying drawings, in which:

FIG. 1A is a diagram illustrating an LED driving system and FIG. 1B illustrates driving of light-emitting diodes;

FIG. 2 is a block diagram illustrating a configuration of an electronic device according to an embodiment of the disclosure;

FIG. 3 is a diagram for illustrating a configuration of a circuit of an electronic device according to an embodiment of the disclosure;

FIGS. 4, 5, 6, 7, and 8 are diagrams for sequentially illustrating operations of an electronic device according to an embodiment of the disclosure;

FIG. 9 and FIG. 10 are diagrams for illustrating a control method of a plurality of light-emitting diodes according to an embodiment of the disclosure; and

FIG. 11 is a flow chart for illustrating a control method of an electronic device according to an embodiment of the disclosure.

### DETAILED DESCRIPTION

The purpose of the disclosure is in providing an electronic device that improves power efficiency by recovering power remaining in a circuit including light-emitting diodes, and then using the recovered power in driving of the light-emitting diodes, and a control method thereof.

Below, the disclosure will be described in detail with reference to the accompanying drawings.

As terms used with respect to embodiments of the disclosure, general terms that are currently used widely were selected as far as possible, in consideration of the functions described in the disclosure. However, the terms may vary depending on the intention of those skilled in the art who work in the pertinent field, previous court decisions, or emergence of new technologies, etc. Also, in particular cases, there may be terms that were designated by the applicant on his own, and in such cases, the meaning of the terms will be described in detail in the relevant descriptions in the disclosure. Accordingly, the terms used in the disclosure should be defined based on the meaning of the terms and the overall content of the disclosure, but not just based on the names of the terms.

Also, in this specification, expressions such as “have,” “may have,” “include,” and “may include” denote the existence of such characteristics (e.g.: elements such as numbers, functions, operations, and components), and do not exclude the existence of additional characteristics.

In addition, the expression “at least one of A or B” should be interpreted to mean any one of “A” or “B” or “A and B.”

Further, the expressions “first,” “second,” and the like used in this specification may describe various elements regardless of any order and/or degree of importance. Also, such expressions are used only to distinguish one element from another element, and are not intended to limit the elements.

In addition, singular expressions include plural expressions, unless defined obviously differently in the context. Further, in the disclosure, terms such as “include” and “consist of” should be construed as designating that there are such characteristics, numbers, steps, operations, elements, components, or a combination thereof described in the specification, but not as excluding in advance the existence or possibility of adding one or more of other characteristics, numbers, steps, operations, elements, components, or a combination thereof.

Also, in this specification, the term “user” may refer to a person who uses an electronic device or a device using an electronic device (e.g.: an artificial intelligence electronic device).

Hereinafter, various embodiments of the disclosure will be described in more detail with reference to the accompanying drawings.

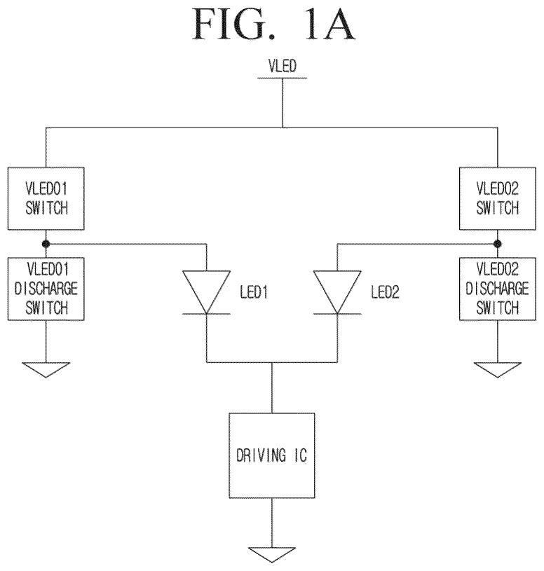

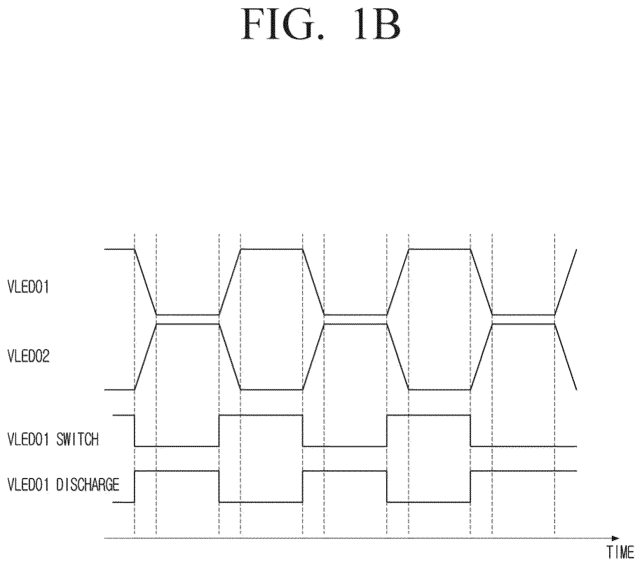

FIG. 1A is a diagram illustrating an LED driving system and FIG. 1B is a diagram illustrating driving of light-emitting diodes.

As illustrated in FIG. 1A, a first light-emitting diode (LED1) and a second light-emitting diode (LED2) may alternately operate according to control by a driving integrated circuit (IC), and the operations of the first light-emitting diode (LED1) and the second light-emitting diode (LED2) will be explained with reference to FIG. 1B.

First, a VLED01 switch is turned on, and a VLED01 discharge switch is turned off, and power (VLED) is supplied to the first light-emitting diode (LED1). Although not illustrated in FIG. 1B, a VLED02 switch is turned off, and a VLED02 discharge switch is turned on at the same time as this, and the second light-emitting diode (LED2) may be connected to the ground. Accordingly, the voltage of the first light-emitting diode (LED1) may be changed from a low value to a high value, and the voltage of the second light-emitting diode (LED2) may be changed from a high value to a low value. That is, the first light-emitting diode (LED1) may emit a light, and the second light-emitting diode (LED2) may not emit a light.

Afterwards, the VLED01 switch is turned off, and the VLED01 discharge switch is turned on, and the first light-emitting diode (LED1) may be connected to the ground. At the same time as this, the VLED02 switch is turned on, and the VLED02 discharge switch is turned off, and power is supplied to the second light-emitting diode (LED2). Accordingly, the voltage of the first light-emitting diode (LED1) may be changed from a high value to a low value, and the voltage of the second light-emitting diode (LED2) may be changed from a low value to a high value. That is, the first light-emitting diode (LED1) that was emitting a light may not emit a light, and the second light-emitting diode (LED2) that was not emitting a light may emit a light.

The first light-emitting diode (LED1) and the second light-emitting diode (LED2) may alternately operate by a method as above.

Here, when the first light-emitting diode (LED1) is turned off, power may remain in the inside of the first light-emitting diode (LED1), and wiring between the VLED01 switch and the first light-emitting diode (LED1), etc., and the remaining power gets to flow to the ground as the VLED01 discharge switch is turned on. Also, when the second light-emitting diode (LED2) is turned off, power may remain in the inside of the second light-emitting diode (LED2), and wiring between the VLED02 switch and the second light-emitting diode (LED2), etc., and the remaining power gets to flow to the ground as the VLED02 discharge switch is turned on. That is, while each of the first light-emitting diode (LED1) and the second light-emitting diode (LED2) is repeating turn-ons and turn-offs, the remaining power gets to flow to the ground, and thus power may not be used efficiently.

In FIG. 1A and FIG. 1B, an LED driving system to which time-division driving is applied was suggested as an example, for the convenience of explanation, but there may be the same problem in case on/off of light-emitting diodes is repeated.

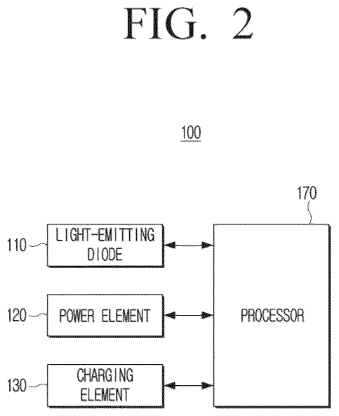

FIG. 2 is a block diagram illustrating a configuration of the electronic device 100 according to an embodiment of the disclosure.

The electronic device 100 may be a device that includes light-emitting diodes, and periodically turns on/turns off the light-emitting diodes. For example, the electronic device 100 may be an LED driving system to which time-division driving is applied (PM driving, time-division AM driving). Alternatively, the electronic device 100 may be implemented in a form of including a backlight and a control circuit therefor of a liquid crystal display (LCD) TV, an LED TV, etc. Alternatively, the electronic device 100 may be implemented in a form of including each LED and a control circuit therefor of a micro LED TV.

However, the disclosure is not limited thereto, and the electronic device 100 can be any device if it includes light-emitting diodes, and periodically turns on/turns off the light-emitting diodes. Also, the electronic device 100 can be any device if includes light-emitting diodes, and repeats turn-ons/turn-offs of the light-emitting diodes, although not by a predetermined cycle.

The electronic device 100 includes a light-emitting diode 110, a power element 120, a charging element 130, and a processor 170.

The light-emitting diode 110 is a semiconductor element that converts a current into a light, and may emit a light based on power supplied from the power element 120. However, the disclosure is not limited thereto, and any element that can emit a light can be used instead of the light-emitting diode 110.

The power element 120 may be a device that outputs power to the light-emitting diode 110. For example, the power element 120 may be a device that applies a predetermined voltage to the light-emitting diode 110.

The charging element 130 may be a device that charges power. For example, the charging element 130 may be implemented in a form including an inductor and a capacitor of which one side is connected to the inductor and the other side is grounded. However, the disclosure is not limited thereto, and the charging element 130 can be in any form if it is a form that can charge power.

The processor 170 may supply first power output from the power element 120 to the light-emitting diode 110, and as supply of the first power is stopped (e.g., based on the supply of the first power being stopped), charge second power which is the remaining power after emission of the light-emitting diode 110 ends in the charging element 130, and end the charging, and ground a node connected to one end of the light-emitting diode 110.

For example, the electronic device 100 may further include a first switch connected between the one end of the light-emitting diode 110 and the power element 120, a second switch connected between the one end of the light-emitting diode 110 and the charging element 130, and a third switch connected between the one end of the light-emitting diode 110 and the ground, and the processor 170 may turn on the first switch to supply the first power output from the power element 120 to the light-emitting diode 110. In this case, the light-emitting diode 110 may emit a light. The processor 170 may turn off the first switch and turn on the second switch to charge the second power which is the remaining power after emission of the light-emitting diode 110 ends in the charging element 130. For example, if the processor 170 turns off the first switch and turns on the second switch, emission of the light-emitting diode 110 ends, and the second power which is the power remaining in the node and the light-emitting diode 110 may be charged in the charging element 130 through the second switch. The voltage on both ends of the light-emitting diode 110 may decrease as the first power is not supplied. The processor 170 may turn off the second switch and turn on the third switch to ground the node. Here, the node may be a node to which the first switch, the second switch, and the third switch are connected.

Each of the first switch, the second switch, and the third switch may be implemented as an electronic switch. For example, each of the first switch, the second switch, and the third switch may be implemented as a transistor. However, the disclosure is not limited thereto, and each of the first switch, the second switch, and the third switch may be implemented as a mechanical switch, and the switches can be implemented by any method if it is a method by which a switching operation is possible.

Hereinafter, for the convenience of explanation, it will be explained that the electronic device 100 includes the first switch, the second switch, and the third switch. However, embodiments of the disclosure are not limited thereto, and the first switch, the second switch, and the third switch can be replaced by any different components.

The processor 170 may turn off the third switch and turn on the second switch to supply third power charged in the charging element 130 to the light-emitting diode 110. Here, the entire second power which is the power remaining in the node and the light-emitting diode 110 is not charged in the charging element 130, and thus the third power may be smaller than the second power. The voltage on both ends of the light-emitting diode 110 may increase as the third power is supplied.

The processor 170 may turn off the second switch and turn on the first switch to supply the first power to the light-emitting diode 110. Here, the voltage on both ends of the light-emitting diode 110 may be in an increased state as the third power was supplied, and thus consumption of the first power can be reduced.

The processor 170 may repeat turn-ons/turn-offs of the light-emitting diode 110 by repeating the operation as above, and may reduce the power consumption of the electronic device 100 in this process through charging/discharging operations using the charging element 130 compared to a case wherein there are no charging/discharging operations.

After the processor 170 supplies the third power to the light-emitting diode 110, if a difference between the voltage of the light-emitting diode 110 and the voltage of the power element 120 is smaller than a predetermined difference, the processor 170 may turn off the second switch and turn on the first switch to supply the first power to the light-emitting diode 110.

For example, the electronic device 100 may further include an element that senses a voltage of the light-emitting diode 110, and after the processor 170 supplies the third power to the light-emitting diode 110, if a difference between the voltage of the light-emitting diode 110 sensed through the element and the voltage of the power element 120 is smaller than the predetermined difference, the processor 170 may turn off the second switch and turn on the first switch to supply the first power to the light-emitting diode 110.

Alternatively, after the processor 170 supplies the third power to the light-emitting diode 110, if a predetermined first time passes, the processor 170 may turn off the second switch and turn on the first switch to supply the first power to the light-emitting diode 110. That is, after the processor 170 supplies the third power to the light-emitting diode 110, if the predetermined first time passes, the processor 170 may identify that a difference between the voltage of the light-emitting diode 110 and the voltage of the power element 120 is smaller than the predetermined difference.

After the processor 170 charges the second power in the charging element 130, if the voltage of the light-emitting diode 110 is smaller than a predetermined voltage, the processor 170 may turn off the second switch and turn on the third switch to ground the node.

For example, the electronic device 100 may further include an element that senses a voltage of the light-emitting diode 110, and after the processor 170 charges the second power in the charging element 130, if the voltage of the light-emitting diode 110 sensed through the element is smaller than the predetermined voltage, the processor 170 may turn off the second switch and turn on the third switch to ground the node.

Alternatively, after the processor 170 charges the second power in the charging element 130, if a predetermined second time passes, the processor 170 may turn off the second switch and turn on the third switch to ground the node. That is, after the processor 170 charges the second power in the charging element 130, if the predetermined second time passes, the processor 170 may identify that the voltage of the light-emitting diode 110 is smaller than the predetermined voltage.

The electronic device 100 may further include a driving integrated circuit (IC) connected to the other end of the light-emitting diode 110, and while the first switch is turned on, the processor 170 may control the driving IC such that a current is applied to the light-emitting diode 110. Here, if the voltage on both ends of the light-emitting diode 110 is smaller than the predetermined voltage, the driving IC may not output a current. In case the driving IC outputs a current while the voltage on both ends of the light-emitting diode 110 is smaller than the predetermined voltage, a transient phenomenon may occur in turning on the light-emitting diode 110, and thus the user may feel flickering. If the voltage on both ends of the light-emitting diode 110 is smaller than the predetermined voltage as above, the driving IC can resolve the user's inconvenience by not outputting a current.

In the above, it was explained that one light-emitting diode 110 repeats turn-ons/turn-offs, but the disclosure is not limited thereto, and it is also possible that each of a plurality of light-emitting diodes repeats turn-ons/turn-offs.

For example, the electronic device 100 may further include another light-emitting diode, another charging element, a fourth switch connected between one end of the another light-emitting diode and the power element 120, a fifth switch connected between the one end of the another light-emitting diode and the another charging element, and a sixth switch connected between the one end of the another light-emitting diode and the ground, and the processor 170 may control the first switch, the second switch, the third switch, the fourth switch, the fifth switch, and the sixth switch such that the light-emitting diode 110 and the another light-emitting diode alternately emit a light.

The processor 170 may turn off the second switch and turn on the third switch, and turn on the fourth switch to supply the first power output from the power element 120 to the another light-emitting diode, and turn off the third switch and turn on the second switch, and turn off the fourth switch and turn on the fifth switch to charge fourth power which is the remaining power after emission of the another light-emitting diode ends in the another charging element, and turn off the second switch and turn on the first switch, and turn off the fifth switch and turn on the sixth switch to ground another node to which the fourth switch, the fifth switch, and the sixth switch are connected.

Also, the processor 170 may turn off the sixth switch and turn on the fifth switch to supply fifth power charged in the another charging element to the another light-emitting diode, and turn off the fifth switch and turn on the fourth switch to supply the first power to the another light-emitting diode.

The electronic device 100 may further include a driving IC connected to the other end of the light-emitting diode 110 and the other end of the another light-emitting diode, and while the first switch is turned on, the processor 170 may control the driving IC such that a current is applied to the light-emitting diode 110, or while the fourth switch is turned on, control the driving IC such that a current is applied to the another light-emitting diode.

In the aforementioned example, an example wherein two light-emitting diodes alternately operate was explained, but the disclosure is not limited thereto. That is, the disclosure can be applied even if two light-emitting diodes do not alternately operate.

As described above, power consumption of the electronic device 100 can be reduced through charging/discharging operations using the charging element 130.

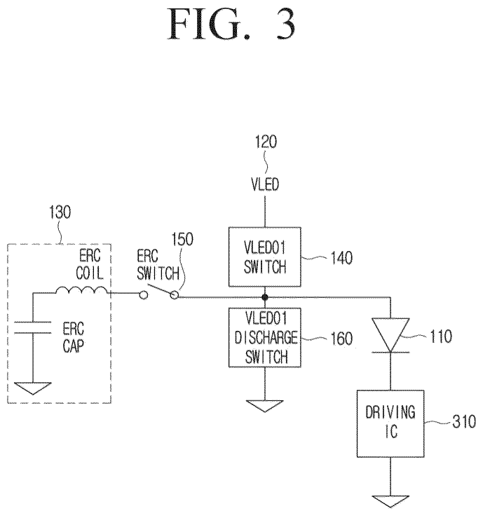

FIG. 3 is a diagram for illustrating a configuration of a circuit of the electronic device 100 according to an embodiment of the disclosure.

As illustrated in FIG. 3, the electronic device 100 may include a light-emitting diode 110, a power element (VLED) 120, a charging element 130, a first switch (a VLED01 switch) 140, a second switch (an ERC switch) 150, a third switch (a VLED01 discharge switch) 160, and a driving IC 310.

One end of the light-emitting diode 110 may be connected to the node to which the first switch 140, the second switch 150, and the third switch 160 are connected, and the other end may be connected to the driving IC 310. The light-emitting diode 110 may emit a light based on a current output from the driving IC 310.

The power element 120 may be connected to the first switch 140.

One end of the charging element 130 may be connected to the second switch 150, and the other end may be grounded. The charging element 130 may be implemented in a form of including an inductor (an ERC coil) and a capacitor (an ERC cap) of which one end is connected to the inductor and the other end is grounded. However, the disclosure is not limited thereto, and the charging element 130 can be implemented in any various circuit forms.

While the first switch 140 is turned on, and the second switch 150 and the third switch 160 are turned off, the driving IC 310 may control the luminance of the light-emitting diode 110 by outputting a current.

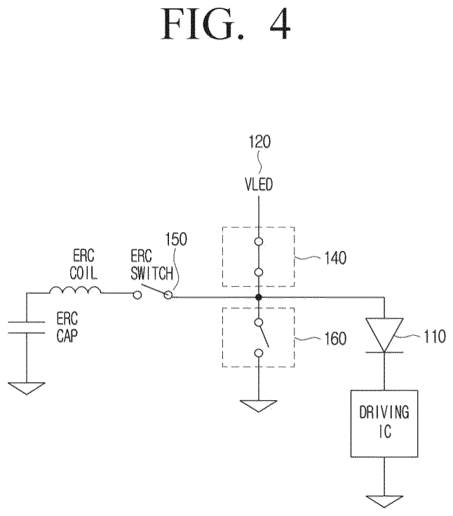

The electronic device 100 may further include a processor 170 that controls the first switch 140, the second switch 150, the third switch 160, and the driving IC 310. Charging/discharging operations according to control by the processor 170 will be explained sequentially through FIG. 4 to FIG. 8.

FIG. 4 to FIG. 8 are diagrams for sequentially illustrating operations of the electronic device 100 according to an embodiment of the disclosure. In FIG. 4 to FIG. 8, for the convenience of explanation, explanation will start from a time point when power is supplied to the light-emitting diode 110.

As illustrated in FIG. 4, the processor 170 may turn on the first switch 140 to supply the first power output from the power element 120 to the light-emitting diode 110. Here, the second switch 150 and the third switch 160 may be in a turned-off state. Here, turn-on of each switch means a state wherein the switch is shorted, and turn-off means a state wherein the switch is opened.

While the first switch 140 is turned on, the processor 170 may control the driving IC such that a current is applied to the light-emitting diode 110. That is, the luminance of the light-emitting diode 110 may be determined based on a current output from the driving IC. While the light-emitting diode 110 emits a light, the electronic device 100 may be in a state wherein power is supplied to the node to which the first switch 140, the second switch 150, and the third switch 160 are connected, and the light-emitting diode 110.

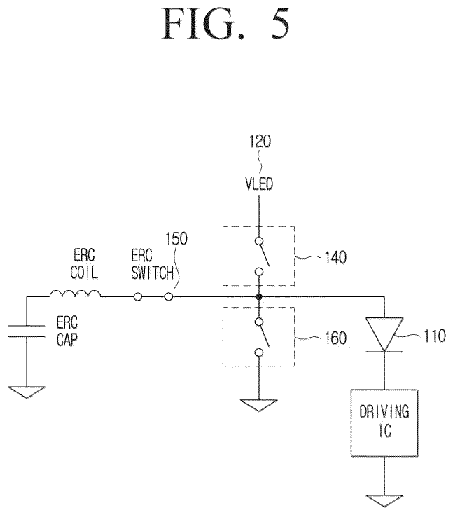

As illustrated in FIG. 5, the processor 170 may turn off the first switch 140 and turn on the second switch 150 to charge the second power which is the remaining power after emission of the light-emitting diode 110 ends in the charging element 130. Here, the third switch 160 may maintain a turned-off state. Also, the processor 170 may control the driving IC to not output a current. In case the electronic device 100 does not include the charging element 130, the second power may be power that is dumped through grounding.

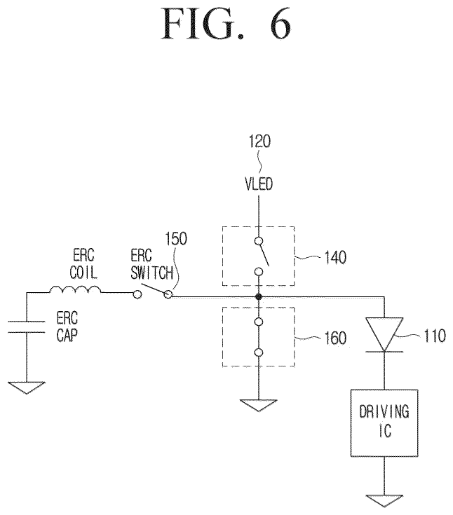

As illustrated in FIG. 6, the processor 170 may turn off the second switch 150 and turn on the third switch 160 to ground the node to which the first switch 140, the second switch 150, and the third switch 160 are connected. Here, the first switch 140 may be in a turned-off state, and the driving IC may also maintain a state of not outputting a current. Through such an operation, the light-emitting diode 110 can be initialized.

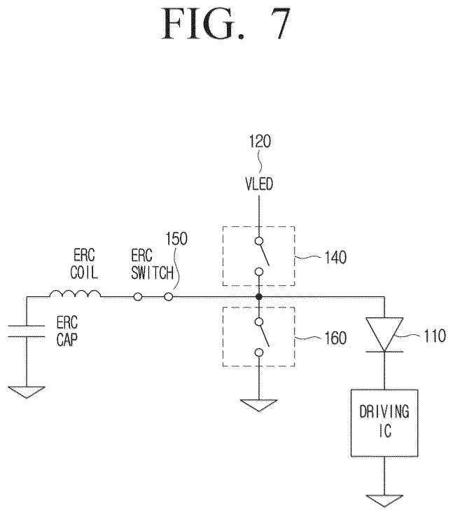

As illustrated in FIG. 7, the processor 170 may turn off the third switch 160 and turn on the second switch 150 to supply the third power charged in the charging element 130 to the light-emitting diode 110. Here, the first switch 140 may be in a turned-off state, and the driving IC may also maintain a state of not outputting a current.

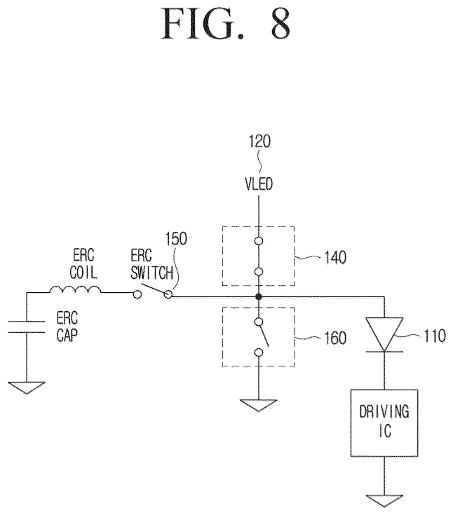

As illustrated in FIG. 8, the processor 170 may turn off the second switch 150 and turn on the first switch 140 to supply the first power to the light-emitting diode 110. Also, while the first switch 140 is turned on, the processor 170 may control the driving IC such that a current is applied to the light-emitting diode 110. Here, the third switch 160 may be in a turned-off state.

As the light-emitting diode 110 was being supplied with the third power, consumption of the first power can be reduced more than in a case wherein the light-emitting diode 110 is not supplied with the third power.

Afterwards, the processor 170 may repeat the operations in FIG. 4 to FIG. 8, and as turn-ons/turn-offs of the light-emitting diode 110 are repeated compared to the past, the amount of power saving increases.

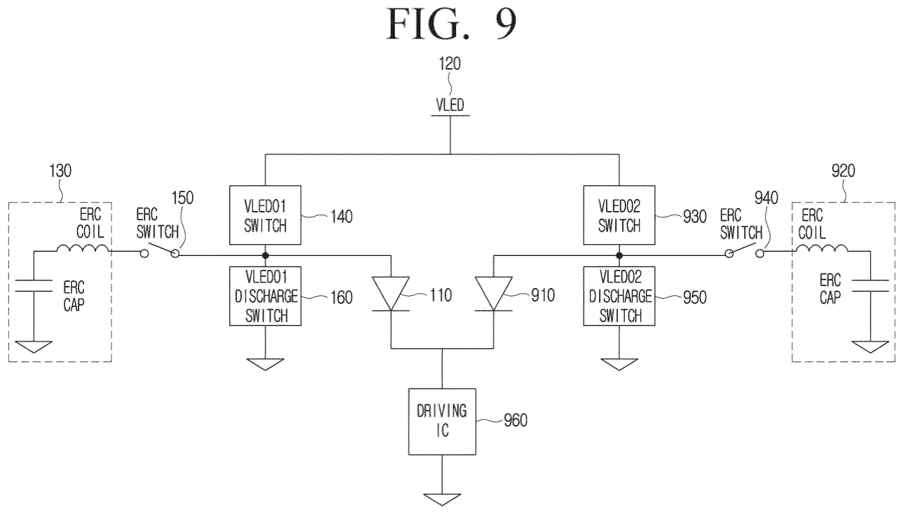

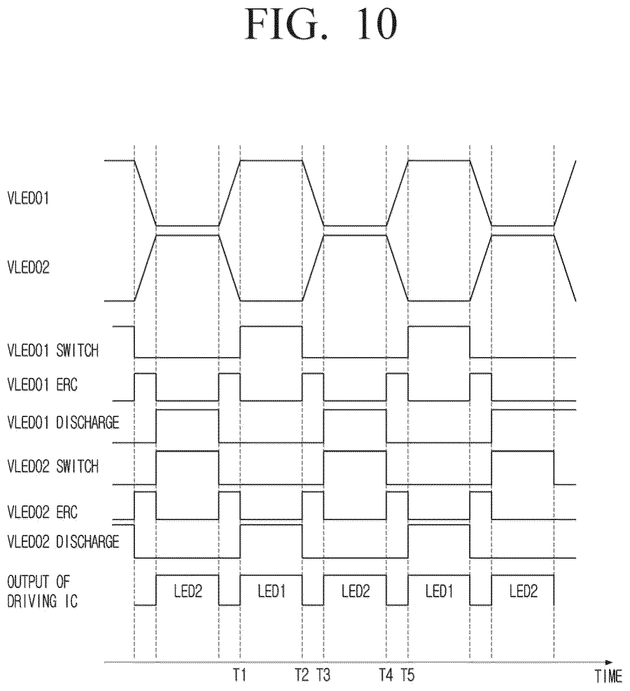

FIG. 9 and FIG. 10 are diagrams for illustrating a control method of a plurality of light-emitting diodes according to an embodiment of the disclosure.

As illustrated in FIG. 9, the electronic device 100 may include a light-emitting diode 110, another light-emitting diode 910, a power element (VLED) 120, a charging element 130, another charging element 920, a first switch (a VLED01 switch) 140, a second switch (an ERC switch) 150, a third switch (a VLED01 discharge switch) 160, a fourth switch (a VLED02 switch) 930, a fifth switch (an ERC switch) 940, a sixth switch (a VLED02 discharge switch) 950, and a driving IC 960. Also, the electronic device 100 may further include a processor 170 that controls the first switch 140, the second switch 150, the third switch 160, the fourth switch 930, the fifth switch 940, the sixth switch 950, and the driving IC 960.

The processor 170 may turn off the second switch 150 and turn on the first switch 140 to supply the first power output from the power element 120 to the light-emitting diode 110, and turn off the fifth switch 940 and turn on the sixth switch 950 to ground another node to which the fourth switch 930, the fifth switch 940, and the sixth switch 950 are connected on the t1 point in FIG. 10.

The processor 170 may turn off the first switch 140 and turn on the second switch 150 to charge the second power which is the remaining power after emission of the light-emitting diode 110 ends in the charging element 130, and turn off the sixth switch 950 and turn on the fifth switch 940 to supply the fifth power charged in the another charging element 920 to the another light-emitting diode 910 on the t2 point in FIG. 10.

The processor 170 may turn off the second switch 150 and turn on the third switch 160 to ground the node to which the first switch 140, the second switch 150, and the third switch 160 are connected, and turn off the fifth switch 940 and turn on the fourth switch 930 to supply the first power output from the power element 120 to the another light-emitting diode 910 on the t3 point in FIG. 10.

The processor 170 may turn off the third switch 160 and turn on the second switch 150 to supply the third power charged in the charging element 130 to the light-emitting diode 110, and turn off the fourth switch 930 and turn on the fifth switch 940 to charge the fourth power which is the remaining power after emission of the another light-emitting diode 910 ends in the another charging element 920 on the t4 point in FIG. 10.

The operation of the processor 170 on the t5 point in FIG. 10 is identical to the operation on the t1 point in FIG. 10, and the processor 170 may repeat the operations on the t1 point to the t4 point afterwards.

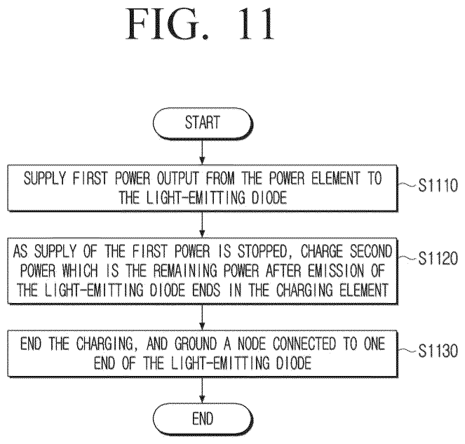

FIG. 11 is a flow chart for illustrating a control method of an electronic device according to an embodiment of the disclosure.

First, first power output from the power element is supplied to the light-emitting diode in the step S1110. Then, as supply of the first power is stopped, second power which is the remaining power after emission of the light-emitting diode ends is charged in the charging element in the step S1120. Then, the charging is ended, and a node connected to one end of the light-emitting diode is grounded.

Also, in the providing step S1110, a first switch connected between the one end of the light-emitting diode and the power element may be turned on to supply the first power to the light-emitting diode, and in the charging step S1120, the first switch may be turned off and a second switch connected between the one end of the light-emitting diode and the charging element may be turned on to charge the second power in the charging element. Further, in the grounding step S1130, the second switch may be turned off and a third switch connected between the one end of the light-emitting diode and the ground may be turned on to ground the node.

Also, the control method may further include the step of, while the first switch is turned on, controlling a driving integrated circuit (IC) connected to the other end of the light-emitting diode such that a current is applied to the light-emitting diode.

In addition, in the step of controlling the driving IC, based on a voltage on both ends of the light-emitting diode being smaller than a predetermined voltage, the driving IC may be controlled to not output the current.

Also, the control method may further include the steps of turning off the third switch and turning on the second switch to supply third power charged in the charging element to the light-emitting diode, and turning off the second switch and turning on the first switch to supply the first power to the light-emitting diode.

In addition, in the step of turning off the second switch and turning on the first switch to supply the first power to the light-emitting diode, after supplying the third power to the light-emitting diode, based on a difference between a voltage of the light-emitting diode and a voltage of the power element being smaller than a predetermined difference, the second switch may be turned off and the first switch may be turned on to supply the first power to the light-emitting diode.

Further, in the grounding step S1130, after charging the second power in the charging element, based on a voltage of the light-emitting diode being smaller than a predetermined voltage, the second switch may be turned off and the third switch may be turned on to ground the node.

Also, the control method may further include the step of controlling the first switch, the second switch, the third switch, a fourth switch connected between one end of the another light-emitting diode and the power element, a fifth switch connected between the one end of the another light-emitting diode and the another charging element, and a sixth switch connected between the one end of the another light-emitting diode and the ground such that the light-emitting diode and the another light-emitting diode alternately emit a light.

In addition, the control method may further include the steps of turning off the second switch and turning on the third switch, and turning on the fourth switch to supply first power output from the power element to the another light-emitting diode, turning off the third switch and turning on the second switch, and turning off the fourth switch and turning on the fifth switch to charge fourth power which is the remaining power after emission of the another light-emitting diode ends in the another charging element, and turning off the second switch and turning on the first switch, and turning off the fifth switch and turning on the sixth switch to ground another node to which the fourth switch, the fifth switch, and the sixth switch are connected.

Also, the control method may further include the steps of turning off the sixth switch and turning on the fifth switch to supply fifth power charged in the another charging element to the another light-emitting diode, and turning off the fifth switch and turning on the fourth switch to supply the first power to the another light-emitting diode.

In addition, the control method may further include the step of, while the first switch is turned on, controlling a driving IC connected to the other end of the light-emitting diode and the other end of the another light-emitting diode such that a current is applied to the light-emitting diode, or while the fourth switch is turned on, controlling the driving IC such that a current is applied to the another light-emitting diode.

Further, the second power may be power remaining in the node and the light-emitting diode.

According to the various embodiments of the disclosure as above, power consumption of an electronic device can be reduced through charging/discharging operations using a charging element.

Also, the disclosure can be applied to a plurality of LEDs or micro LEDs, etc. included in a backlight, and as there is a substantial number of LEDs included in the plurality of LEDs or micro LEDs, etc. included in the backlight, the amount of power saving can be substantial.

According to an embodiment of the disclosure, the aforementioned various embodiments may be implemented as software including instructions stored in machine-readable storage media, which can be read by machines (e.g.: computers). The machines refer to devices that call instructions stored in a storage medium, and can operate according to the called instructions, and the devices may include an electronic device according to the aforementioned embodiments (e.g.: an electronic device A). In case an instruction is executed by a processor, the processor may perform a function corresponding to the instruction by itself, or by using other components under its control. An instruction may include a code that is generated or executed by a compiler or an interpreter. A storage medium that is readable by machines may be provided in the form of a non-transitory storage medium. Here, the term ‘non-transitory’ only means that a storage medium does not include signals and is tangible, and the term does not distinguish a case wherein data is stored in the storage medium semi-permanently and a case wherein data is stored temporarily.

Also, according to an embodiment of the disclosure, the method according to the aforementioned various embodiments may be provided while being included in a computer program product. A computer program product refers to a product, and it can be traded between a seller and a buyer. A computer program product can be distributed in the form of a storage medium that is readable by machines (e.g.: compact disc read only memory (CD-ROM)), or distributed on-line through an application store (e.g.: Play Store™). In the case of on-line distribution, at least a portion of a computer program product may be stored in a storage medium such as the server of the manufacturer, the server of the application store, and the memory of the relay server at least temporarily, or may be generated temporarily.

In addition, according to an embodiment of the disclosure, the aforementioned various embodiments may be implemented in a recording medium that can be read by a computer or a device similar to a computer, by using software, hardware, or a combination thereof. In some cases, embodiments described in this specification may be implemented as a processor itself. According to implementation by software, embodiments such as procedures and functions described in this specification may be implemented as separate software. Each software can perform one or more functions and operations described in this specification.

Computer instructions for performing processing operations of a device according to the aforementioned various embodiments may be stored in a non-transitory computer-readable medium. Computer instructions stored in such a non-transitory computer-readable medium make the processing operations of a device according to the aforementioned various embodiments performed by a specific machine, when the instructions are executed by the processor of the specific machine. A non-transitory computer-readable medium refers to a medium that stores data semi-permanently, and is readable by machines, but not a medium that stores data for a short moment such as a register, a cache, and memory. As specific examples of a non-transitory computer-readable medium, there may be a CD, a DVD, a hard disc, a blue-ray disc, a USB, a memory card, ROM and the like.

Also, each of the components (e.g.: a module or a program) according to the aforementioned various embodiments may consist of a singular object or a plurality of objects. In addition, among the aforementioned corresponding sub components, some sub components may be omitted, or other sub components may be further included in the various embodiments. Alternatively or additionally, some components (e.g.: a module or a program) may be integrated as an object, and perform functions that were performed by each of the components before integration identically or in a similar manner. Further, operations performed by a module, a program, or other components according to the various embodiments may be executed sequentially, in parallel, repetitively, or heuristically. Or, at least some of the operations may be executed in a different order or omitted, or other operations may be added.

In addition, while embodiments of the disclosure have been shown and described, the disclosure is not limited to the aforementioned specific embodiments, and it is apparent that various modifications may be made by those having ordinary skill in the technical field to which the disclosure belongs, without departing from the gist of the disclosure as claimed by the appended claims. Further, it is intended that such modifications are not to be interpreted independently from the technical idea or prospect of the disclosure.

What is claimed is:

1. An electronic device comprising:
a first light-emitting diode;
a power element;
a first charging element;
memory storing instructions; and
at least one processor operatively connected to the first light-emitting diode, the power element, and the first charging element,
wherein the instructions, when executed by the at least one processor individually or collectively, cause the electronic device to:
supply a first power from the power element to the first light-emitting diode,
based on the supply of the first power being stopped, charge a second power, which is a remaining power after emission of the first light-emitting diode ends, using the first charging element, and
end the charge of the second power, and ground a node connected to a first end of the first light-emitting diode.

2. The electronic device of claim 1, further comprising:
a first switch connected between the first end of the first light-emitting diode and the power element;
a second switch connected between the first end of the first light-emitting diode and the first charging element; and
a third switch connected between the first end of the first light-emitting diode and a ground,
wherein the instructions, when executed by the at least one processor individually or collectively, cause the electronic device to:
supply the first power to the first light-emitting diode by turning on the first switch,
charge the second power in the first charging element by turning off the first switch and turning on the second switch, and
ground the node by turning off the second switch and turning on the third switch.

3. The electronic device of claim 2, further comprising:
a driving integrated circuit (IC) connected to a second end of the first light-emitting diode,
wherein the instructions, when executed by the at least one processor individually or collectively, cause the electronic device to, while the first switch is turned on, control the driving IC such that a current is applied to the first light-emitting diode.

4. The electronic device of claim 3, wherein the driving IC is configured to, based on a voltage on the first and second ends of the first light-emitting diode being smaller than a predetermined voltage, not provide the current.

5. The electronic device of claim 2, wherein the instructions, when executed by the at least one processor individually or collectively, cause the electronic device to:
supply a third power charged in the first charging element to the first light-emitting diode by turning off the third switch and turning on the second switch, and
supply the first power to the first light-emitting diode by turning off the second switch and turning on the first switch.

6. The electronic device of claim 5, wherein the instructions, when executed by the at least one processor individually or collectively, cause the electronic device to, after supplying the third power to the first light-emitting diode, based on a difference between a voltage of the first light-emitting diode and a voltage of the power element being smaller than a predetermined difference, supply the first power to the first light-emitting diode by turning off the second switch and turning on the first switch.

7. The electronic device of claim 2, wherein the instructions, when executed by the at least one processor individually or collectively, cause the electronic device to, after charging the second power in the first charging element, based on a voltage of the first light-emitting diode being smaller than a predetermined voltage, ground the node by turning off the second switch and turning on the third switch.

8. The electronic device of claim 2, further comprising:
a second light-emitting diode;
a second charging element;
a fourth switch connected between a first end of the second light-emitting diode and the power element;
a fifth switch connected between the first end of the second light-emitting diode and the second charging element; and
a sixth switch connected between the first end of the second light-emitting diode and the ground,
wherein the instructions, when executed by the at least one processor individually or collectively, cause the electronic device to control the first switch, the second switch, the third switch, the fourth switch, the fifth switch, and the sixth switch such that the first light-emitting diode and the second light-emitting diode alternately emit a light.

9. The electronic device of claim 8, wherein the instructions, when executed by the at least one processor individually or collectively, cause the electronic device to:
supply the first power from the power element to the second light-emitting diode by turning off the second switch, turning on the third switch, and turning on the fourth switch,
charge a fourth power, which is a remaining power after emission of the second light-emitting diode ends in the second charging element, by turning off the third switch, turning on the second switch, turning off the fourth switch, and turning on the fifth switch, and
ground another node to which the fourth switch, the fifth switch, and the sixth switch are connected by turning off the second switch, turning on the first switch, and turning off the fifth switch, turning on the sixth switch.

10. The electronic device of claim 9, wherein the instructions, when executed by the at least one processor individually or collectively, cause the electronic device to:
supply a fifth power charged in the second charging element to the second light-emitting diode by turning off the sixth switch and turning on the fifth switch, and
supply the first power to the second light-emitting diode by turning off the fifth switch and turning on the fourth switch.

11. The electronic device of claim 9, further comprising:
a driving IC connected to a second end of the first light-emitting diode and a second end of the second light-emitting diode,
wherein the instructions, when executed by the at least one processor individually or collectively, cause the electronic device to, while the first switch is turned on, control the driving IC such that a current is applied to the first light-emitting diode, or while the fourth switch is turned on, control the driving IC such that the current is applied to the second light-emitting diode.

12. The electronic device of claim 2, wherein the second power is a power remaining in the node and the first light-emitting diode.

13. A control method of an electronic device, the control method comprising:
supplying a first power from a power element to a light-emitting diode;
based on a supply of the first power being stopped, charging a second power, which is a remaining power after emission of the light-emitting diode ends, using a charging element; and
ending the charging of the second power, and grounding a node connected to a first end of the light-emitting diode.

14. The control method of claim 13, wherein the supplying comprises supplying the first power to the light-emitting diode by turning on a first switch connected between the first end of the light-emitting diode and the power element,
wherein the charging comprises charging the second power in the charging element by turning off the first switch and turning on a second switch connected between the first end of the light-emitting diode and the charging element, and
wherein the grounding comprises grounding the node by turning off the second switch and turning on a third switch connected between the first end of the light-emitting diode and a ground.

15. The control method of claim 14, further comprising controlling, while the first switch is turned on, a driving integrated circuit (IC) connected to a second end of the light-emitting diode such that a current is applied to the light-emitting diode.
